(19) United States
(12) Patent Application Publication
(10) Pub. No.: US 2011/0004998 A1
(43) Pub. Date: Jan. 13, 2011

(54) Modular supporting element to make mattresses and the like and mattresses and the like realised with such elements

(75) Inventor: Massimo Losio, Asolo (Treviso) (IT)

Correspondence Address: TUTUNJIAN & BITETTO, P.C., 20 CROSSWAYS PARK NORTH, SUITE 210, WOODBURY, NY, 11797, US

(73) Assignee: TECHNOGEL ITALIA S.r.l., Pozzoleone (Vicenza) (IT)

(21) Appl. No.: 12/919,406

(22) PCT Filed: Feb. 26, 2009
(86) PCT No.: PCT/IB09/50787

§ 371 Date: Aug. 27, 2010

(30) Foreign Application Priority Data
Feb. 26, 2008 (EP) 08003445.7

(51) Int. Cl. A47C 27/00; B68G 7/00

(52) U.S. Cl. 5/699; 5/727; 29/91.1

(57) ABSTRACT

The modular supporting element to make mattresses, pillows and the like comprises a body which is elastically deformable in at least one direction of deformation, the body comprising a first portion having a first modulus of elasticity and a second portion having a second modulus of elasticity which is different from the first modulus of elasticity.

### TECHNICAL FIELD

The invention relates to a modular supporting element to make mattresses, pillows and the like, suitable for allowing the softened support of a person's body in a way adaptable to the needs of parts of it. The invention also relates to the mattresses and the like made with these supporting elements.

### BACKGROUND ART

For some time now mattresses are known and used which are made of a plurality of modular elements that are normally identical and assembled to form a mattress or a pillow.

Each of these modular elements can be made of a single body piece made in an elastically deformable material or of an elastic hollow body designed to hold a fluid substance, for example gel, allowing the hollow body to deform elastically.

A mattress made with these modular elements allows the conformation of the resting surface of a person's body to adapt to his/her specific conformation and needs.

For this reason these mattresses, that comprise a plurality of modular elements, are used especially in the medical sector when a patient has to lie in bed for a particularly long period of hospitalization.

With the structure of these mattresses the negative effects resulting from so-called “decubitus”, i.e. from a progressive irritation and deterioration of the skin that is in constant contact with the mattress up to a point where it develops into sores, can be avoided or at least reduced considerably.

In fact, the total weight of the body is divided between all the modular elements that deform elastically, becoming squashed, to create a resting surface that adapts automatically to the morphological characteristics of the body resting on top of it and, for this reason, it is also possible to provide elements that have moduli of elasticity different from each other thus defining areas of the mattress that are more or less rigid.

These mattresses are also used when a person who has to lie down has specific painful pathologies, for example of the back or spine.

Also in these cases it is possible to provide areas of the mattress that have a stiffer structure compared to others where it has a more yielding structure.

If the modular elements are made of hollow bodies with a fluid inside, it is also contemplated that the insides of the modular elements are connected together, so the fluid can distribute itself automatically when a body lies down on the mattress.

In other words, the fluid migrates from elements that are very loaded to other elements that are not so loaded, compensating for the deformations.

In some cases it is also contemplated that the modular elements are placed in communication with the fluid supply sources that are able to modify the volumes of the fluid according to necessity and in such a way as to increase or reduce the stiffness of the mattress.

One mattress to support a body lying down is known by the U.S. Pat. No. 6,829,797.

According to this patent a mattress is provided that is made up of a plurality of deformable cylindrical elements mounted on a flat base.

The cylindrical elements contain a fluid, for example gel or air, and are connected together in such a way as to compensate for the deformations between the cylindrical elements compressed by the weight of a person and the unloaded cylindrical elements.

It is also contemplated that these cylindrical elements are divided into two groups differing in height, so as to form with a first group a first resting surface at a higher level and with a second group a second resting surface at a lower level.

Thanks to this characteristic the fluid can be fed at different pressures to the elements that form the first group compared to those that form the second group.

Another mattress is known with the US patent application No.: US 2007/0113352 A1.

This patent application concerns a therapeutic mattress in which areas are defined that yield differently one from the other.

To obtain these areas the mattress is divided into parallel and adjacent sections made alternatively with modular bodies of synthetic foams and modular elements made with inflatable bodies or that can be filled with gel.

In this way it is possible to make a mattress where we can differentiate the stiffness between the different areas where the body rests, for example between the head area and the foot area or lower back area.

Also in this case the bodies that can hold air or gel are made in such a way to be connected together so the fluid they contain can distribute itself in an autonomous way when the mattress has the weight of a body on it or when it is without.

Another mattress formed with modular elements next to each other is known according to French patent No.: FR 2.692.477.

According to this patent a mattress is provided that comprises a plurality of modular elements that can be inflated with a fluid fed by a special feeding and control apparatus for the feeding pressures.

Each modular element comprises a head that forms bellows that extend towards the base of the mattress with a leg, also made in the shape of bellows.

Each modular element is fitted in its hollow seat that is obtained in a containment body that forms the general body of the mattress.

All the modular elements are connected together in such a way as to compensate for the total deformations of the same.

Besides feeding the modular elements with fluid at set pressures, the feeding and control apparatus supplies them with a vibrating effect so the mattress has massaging characteristics, particularly suitable for improving blood circulation and helping the person to relax.

Another mattress formed with modular elements next to each other is known from European Patent No.: EP 934,740.

According to this patent, each modular element rests on its own support that can be moved separately from the others. In turn, the supports touch corresponding linear actuators that are designed to move them vertically and are located between the supports and a base frame. Each modular element is developed lengthways and is arranged crossways with respect to the longitudinal axis of the mattress, by the side and adjacent to other similar elements; in addition, each modular element is made preferably in a foam material, possibly covered with fabric. In addition, according to the patent, it is contemplated that two adjacent modular elements can be operated by a single linear actuator: in this case there is a massaging action also in the longitudinal direction due to the partial rotation of the modular elements around their axis, pushed from the bottom and which makes them turn divergently one from the other.

This prior art does have some shortcomings.

A first shortcoming is that the known modular elements have a substantially single body piece that has its own unique modulus of elasticity.

Therefore, to make mattresses with areas of differing stiffness, it is necessary to produce and use a large number of modular elements, each with its own modulus of elasticity and then arrange the distribution of the various modular elements according to specific schemes to obtain areas that are more or less yielding.

Another shortcoming is that in the case of inflatable modular elements or that contain gel, to obtain an adequate compensation of the deformations between the modular elements that are loaded with the weight of a body, it is necessary that they are connected together, so the fluid is able to move from one element to another and, if necessary, devices to feed the fluid.

Another shortcoming is that if, in a modular element that contains fluid, there is a leak due to damage, the entire portion of the mattress that is made with modular elements connected together, quickly loses its capacity to support a body and it deflates: this means the person lying on it has to be moved immediately and the whole portion has to be replaced.

Another shortcoming is that when is required a mattress made with modular elements that contain a fluid, for example gel, which, as is common knowledge, has good refreshing characteristics for the skin, and that each one has a different modulus of elasticity, it is necessary to make a really large number of such elements and each one has to be filled in a specific way with a certain volume of fluid until the required moduli of elasticity are obtained.

Since each mattress comprises a few hundred modular elements, it is an extremely lengthy process to make and above all costly due to the price of the gel.

Another shortcoming of the known technique is that the known mattresses, after they have been made, have a fixed structure which means their overall dimensions cannot be modified; therefore, transportation costs are relatively high because of their dimensions that cannot be reduced.

Another shortcoming is that transporting these known mattresses is substantially inconvenient and often requires the use of special vehicles with an adequately spacious container.

### DISCLOSURE OF THE INVENTION

One aim of the invention is to improve the prior art.

Another aim of the invention is to make a modular supporting element to make mattresses, pillows and the like that can put next to other similar ones and that when they are next to each other they allow to obtain supporting areas of the same mattress, pillow and the like that also have differentiated stiffness.

Another aim of the invention is to make a modular supporting element to make mattresses, pillows and the like that allows to have a contact and resting surface of a person's body that maintains pleasant contact with it and is also able to limit possible decubitus phenomena.

Another aim of the invention is to make a modular supporting element to make mattresses, pillows and the like that allows to maintain a supporting action even if damaged.

Another aim of the invention is to make a modular supporting element to make mattresses, pillows and the like that allows to make mattresses, pillows and the like quickly according to customizable sizes and also so it can be replaced individually, again quickly, should there be the need to replace it.

Yet another aim of the invention is to make a modular supporting element to make mattresses, pillows and the like that allows to make mattresses, pillows and the like with a resting surface that can have customizable stiffness from one point to another according to specific requirements determined by a particular use or by the preferences of the users.

Some aspects of the invention provide for a modular supporting element to make mattresses, pillows and the like, a mattress, pillow or the like, a method for making mattresses, pillows and the like to support a body according to the claims of this patent.

Therefore, the modular supporting element to make mattresses, pillows and the like, the method for making modular supporting elements to make mattresses, pillows and the like, the method for making mattresses, pillows and the like to support a body, allow:
mattresses, pillows and the like to be made that have a flexibility and elastic characteristics that can be modified from area to area and from point to point of each area according to specific requirements;
mattresses, pillows and the like to be made that have a substantially simple structure and of a size that is quickly adaptable to each requirement of use;
a surface of contact to be obtained with a body that keeps it in the best posture and prevents the formation of sores and decubitus;
skin rashes caused by allergies to be avoided;
the quick replacement of the modular supporting elements, whether it is because they are damaged or whether a request is made to alter the elasticity characteristics;
mattresses, pillows and the like to be made that can be put together or dismantled quickly and easily which, in the latter case, provide particularly reduced dimensions so much so that they can be packed and transported also by hand, limiting costs for their transportation, or be moved easily from one bed to another or from one place to another even with small vehicles or simply by hand;
in the case of need to obtain a mattress that can be used either by placing it on a conventional type bed or by removing it from the bed and putting it on the floor to create a comfortable and temporary resting couch;
a consistent saving of the volumes of gel necessary to make mattresses, pillows and the like and, hence, a saving of production costs.

### BRIEF DESCRIPTION OF THE DRAWINGS

Further characteristics and advantages of the invention will appear more evident from the description of a preferred, but not exclusive, embodiment of a modular element for mattresses, pillows and the like, illustrated indicatively by way of non limiting example, in the attached drawings wherein:

FIG. 1 is a general perspective view of a mattress made with a plurality of modular supporting elements according to the invention;

FIG. 2 is an interrupted cross section of the mattress of FIG. 1, taken according to plane II-II;

FIG. 3 is an interrupted cross section view and on a very enlarged scale of a portion of a mattress made with a second embodiment of the modular supporting elements according to the invention;

FIG. 4 is an interrupted perspective view of a modular element in the second embodiment of FIG. 3, having massaging means;

FIG. 5 is a schematic side view of a product, in this specific case a mattress, having a plurality of modular supporting elements according to the invention and the possibility of being shaped as wanted, in such a way as to follow a profile of an articulated frame of a bed or the like and to keep a resting surface which is correct from an ergonomic point of view;

FIG. 6 is an interrupted perspective view of a modular supporting element in a third embodiment;

FIG. 7 is an interrupted side and partially in section view of a fourth embodiment of a modular supporting element;

FIG. 8 is an interrupted side and partially in section view of a portion of a mattress, pillow and the like in an assembly phase, using the modular supporting elements of FIG. 7;

FIG. 9 is a schematic and perspective view of a mattress, pillow and the like in an assembly phase, using the modular supporting elements of FIG. 7;

FIG. 10 is an interrupted side and partially in section view of a mattress, pillow and the like, modified to reduce its dimensions;

FIG. 11 is an interrupted schematic and section view of an assembly phase of modular supporting elements according to the invention to make a mattress, pillow and the like which has the dimensions wanted;

FIG. 12 is a side schematic view of a modular supporting element of FIG. 3 in a joining or separation phase between a first upper portion and a second lower portion;

FIG. 13 is a schematic and interrupted view on a reduced scale of a joining element in a folding phase to reduce its dimensions;

FIG. 14 is a schematic view on a reduced scale of a portion of a joining element, in a folding phase of a corner to obtain a desired shape;

FIG. 15 is a detailed view of a fifth embodiment of a modular supporting element according to the invention;

FIG. 16 is an interrupted perspective view of a mattress made by joining several modular elements together according to the fifth embodiment of FIG. 5;

FIG. 17 is a section view of the mattress of FIG. 16, taken according to a XVII-XVII plane, where a possible arrangement of the modular supporting elements of FIG. 15 can be seen;

FIG. 18 is a section view of FIG. 17 where an alternative arrangement of the modular elements of FIG. 15 can be seen;

FIG. 19 schematically shows a first possible arrangement of a modular element according to a joining element;

FIG. 20 schematically shows a second possible arrangement of a modular element according to a joining element;

FIG. 21 schematically shows a third possible arrangement of a modular element according to a joining element;

FIG. 22 is a perspective view of a sixth embodiment of a modular supporting element according to the invention;

FIG. 23 is a perspective view of a seventh embodiment of a modular supporting element according to the invention;

FIG. 24 is a perspective view of an eighth embodiment of a modular supporting element according to the invention;

FIG. 25 is a detailed perspective view of a mattress made with supporting elements according to the sixth embodiment of FIG. 22;

FIG. 26 is a detailed perspective view of a mattress made with supporting elements according to the seventh embodiment of FIG. 23 and the eighth embodiment of FIG. 24;

FIG. 27 is a plan view of the joining element used to make the mattresses of FIG. 25 and FIG. 26;

FIG. 28 is a side view of the mattress of FIG. 25 and FIG. 26;

FIG. 29 is a detail of FIG. 28.

### DETAILED DESCRIPTION OF THE PREFERRED EMBODIMENTS OF THE INVENTION

With reference to the Figures, by 1 a first embodiment of a modular supporting element is indicated, suitable for making products such as, for example, mattresses 2, pillows and the like, to support a human body “C” in a softened fashion.

The supporting element 1, or more briefly herein the element 1, comprises a body that is made of at least two portions 1A and 1B that are adjacent and joined together and of which, in a preferred condition of use of the element 1, a first portion 1A is considered upper and a second portion 1B lower, with respect to a possible main direction “Z” of deformation of the element 1.

The forms of the body of this element 1 can be any, depending on the specific requirements of use, for example cylindrical, as indicated in FIG. 2 or generally prismatic, it being understood that by this term both regular and symmetrical, irregular and asymmetrical prismatic forms are included.

According to a preferred embodiment, the body of the element 1 is obtained by joining the first upper portion 1A with the second lower portion 1B, which both have a truncated pyramid shape, normally differing in height but defining two respective minor bases 3 that are the same, so they coincide on a joining surface.

Joining between the two minor bases 3 can be done in various ways: for example gluing them together or contemplating attachment means 70, 80 between them such to allow joining or the separation between the upper portion 1A and the lower portion 1B, as schematically illustrated in FIG. 12.

The first upper portion 1A is therefore an upside down truncated pyramid defining a resting face 4 that coincides with its larger base and which is designed to be faced upwards to receive the resting body 3.

In addition, the first upper portion 1A comprises a containment chamber 5 in which a fluid substance collects, for example polyurethane gel. This type of material reacts to the applied pressure, for example the weight of the user, deforming along the three spatial axes X, Y, Z. This results in a more uniform distribution of the pressure exerted, which reduces the pressure felt by the user at the points of contact and increases the comfort, as well as improving the blood circulation and posture, and avoiding the formation of sores and other types of ulcerations.

The second lower portion 1B is, instead, made preferably with a material more compact than gel but also elastically deformable, for example a plastic/elastomeric foam: in this way the first upper portion 1A has first elastic properties like, for instance, a first modulus of elasticity E1 while the second lower portion 1B has second elastic properties like, for example, a second modulus of elasticity E2 that is different from E1; the two moduli of elasticity E1 and E2 are normally connected together with the inequality relation, E1<E2.

However, it should be noted that in some possible embodiments of the lower portion 1B, for example when it is made in the shape of an elastic foam grid, it can happen that the two moduli of elasticity E1 and E2 are in relation together with an inequality E1>E2.

Therefore this relation is not to be considered binding for the invention.

When, however, E1<E2, the first upper portion 1A is notably more deformable than the second lower portion 1B; the contrary happens when E1>E2.

In this way, the main softening action is obtained with the first upper portion 1A, while the second lower portion 1B has a mainly supporting function; however, if necessary, the lower portion 1B is also able to bend to help obtain a kind of second softening stage with respect to the one provided by the upper portion 1A.

According to the expert in this field, it is however normal routine (and for this reason not illustrated in the Figures) to contemplate that the second lower portion 1B will also comprise its own containment chamber inside which can be contained a fluid that is, for example, denser and less deformable than the fluid contained in the containment chamber 5.

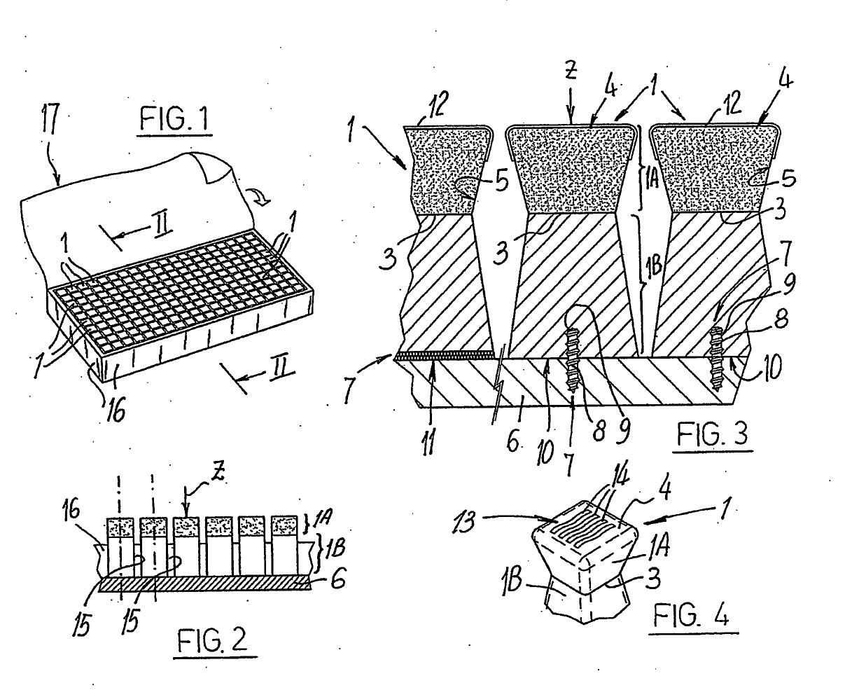

Each element 1, according to the embodiment illustrated in FIGS. 2, 3 and 6 can be mounted together with other elements 1, preferably all identical, on a resting base 6 which can be substantially flat, as indicated in FIGS. 1 and 2, or it can be shaped according to specific requirements, as can be seen in FIG. 5, where the shapeable base is indicated by reference number 106 to distinguish it from the substantially rigid embodiment indicated by reference number 6.

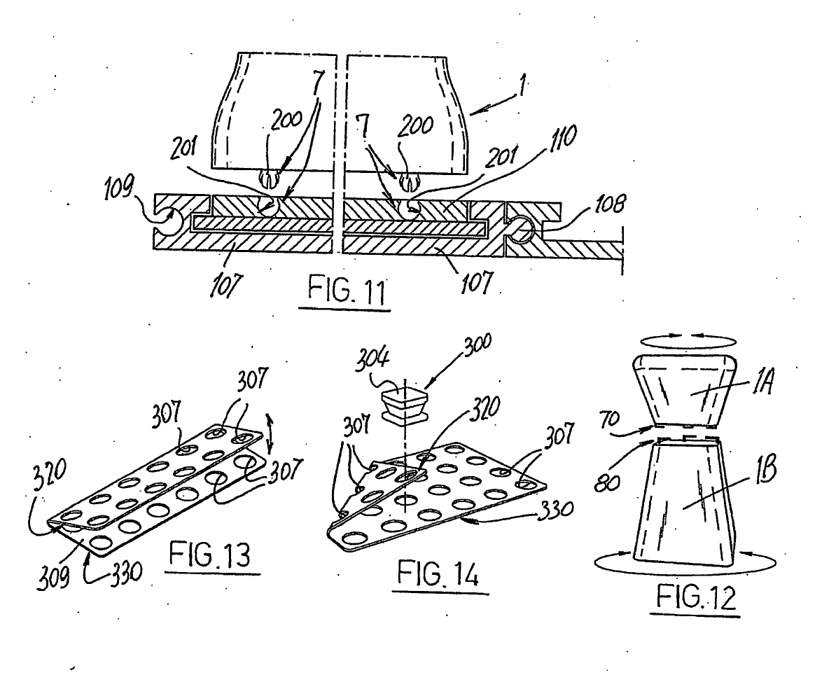

This base 6 can be made in just the one block or also with a set of modular elements joined together to form it according to the dimensions wanted, as can be seen in FIG. 11, where the base 6 is composed of a set of plates 107, normally obtained by cutting a commercial section and which has, on opposite sides, male 108 and female 109 elements that couple together sliding.

The number of plates 107 is predetermined to obtain a base 6 with pre-established dimensions.

Inside plates 107 can be also arranged flat elements 110 to which elements 1 can be fastened in a movable fashion.

Between the second lower portion 1B and the base 6 or 106, restraining means 7 are provided which allow the firm assembly, but movable, if required, of each element 1 on the resting base 6 or 106.

These restraining means 7 can comprise, in a first embodiment, visible on the right for the person looking at FIG. 3, a screw 8 that can be screwed into a corresponding hollow tightening seat 9 that can be made indifferently in the bases 6, 106 or in the second lower portion 1B of the element 1, i.e. in detail, in one restraining face 10 defined in the latter and parallel and opposite the resting face 4.

According to another embodiment, the restraining means 7 can be made of a strip 11 of material known as Velcro® and composed of two portions that adhere together when pressed on top of each other and that are separable by pulling away.

In this case, the embodiment of which can be seen on the left for the person looking at FIG. 3, a portion of the strip 11 is made integral to the restraining face 10, for example with an adhesive material, while the other portion is made integral to the bases 6 or 106.

According to another embodiment illustrated in FIG. 11, the restraining means 7 can be composed of elastically deformable feet 200, that are restrained at the bottom to each element 1 and that are to be inserted, by pressing, into corresponding hollow seats 201 obtained in the flat elements 110 and held inside them.

In all cases it is however possible to assemble the elements 1 fixed firmly to the bases 6 or 106 but also to remove them selectively, if necessary.

According to the invention, on the resting face 4 the application of a covering layer 12 made in an anti-allergic material can also be provided, so the body 3 does not suffer pathological phenomena caused by direct contact with the resting faces 4.

The latter, in the case of specific uses of the mattress 2 (or pillow), can have, as is visible in FIG. 4, protruding massaging elements 13 like, for example, particularly soft and flexible ridges or ribs in relief 14 which, with the movements of the body 3 can even have stimulating effects on the skin to help blood circulation and relaxation.

The elements 1 are mountable on the bases 6 or 106 according to schemes that are established by the user's specific requirements or by the conditions of use and that can have either a checkerboard arrangement or in rows and columns.

In addition, the particular shape of the elements 1 allows to obtain between the latter, when mounted on the bases 6 or 106, free transit interspaces 15 through which air can pass and reach the skin of the body 3 thus preventing perspiration and the formation of painful decubitus.

When the modular elements 1 of softened resting are mounted on the bases 6 or 106 a containment element is put around them like, for example, the sides 16 of an openable containment lining 17, which is made advantageously with a material suitable for not irritating the body “C”.

According to another embodiment of the modular supporting elements, that in this case are indicated with 300 and visible in Figures from 7 to 10, each one of them comprises resting portion 301 and a base portion 302 that are joined together in the same ways as for the modular elements 1 described previously and that is, for example, by means of gluing materials or with the attachment means 70, 80 as can be seen in FIG. 7.

In detail, the resting portion 301 comprises a portion 303 that has specific elastic characteristics obtained, for example, by creating in this a containment chamber for a fluid or a gel.

In this way, the portion 303 has a first modulus of elasticity E1 and defines a resting surface 304, that comes into contact with the human body “C”, and an intermediate portion 305 made, for example, with a foamy polymer material and elastically deformable, that has elastic characteristics different from those of the gel contained in chamber 303, like, for example, a second modulus of elasticity E2 greater than the first modulus of elasticity E1; in other words, the intermediate portion 305 is less flexible than the top portion 303.

The intermediate portion 305 has a shape that has an area turned towards the base portion 302, that is slightly flared in such a way as to form, in the joining area where it joins with it, a substantially flat ring-shaped border 306, which extends around the perimeter towards the outside with respect to this joining area.

The modular supporting elements 300, being elastically deformable, can be pressed with the hands according to necessity to be inserted and held in corresponding holes 307 that are obtained in a joining element 308 which, in this embodiment of the modular elements 300, replaces the bases 6 and 106.

The joining element 308 is essentially composed of a sheet 309 of flexible plastic material, as illustrated in FIG. 9 and of a suitable thickness to withstand stresses.

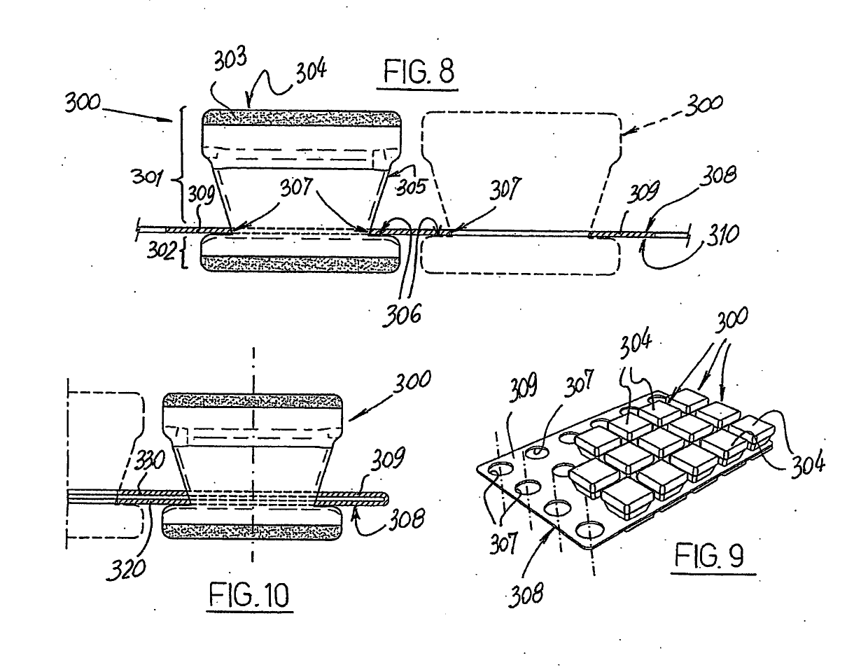

When the modular elements 300 are inserted inside the respective holes 307, with reference to FIG. 8, it can be noticed that the ring-shaped border 306 is substantially in contact with and resting against one face of the sheet 309, indicated with 310: this makes it possible to stabilise the position of the modular elements 300 inside the respective holes 307 to prevent them from slanting and accidentally slipping out.

Simultaneously, the flared surface of the intermediate portion 305 acts as a centering and perimeter holding body for the modular elements 300 in their respective holes 307.

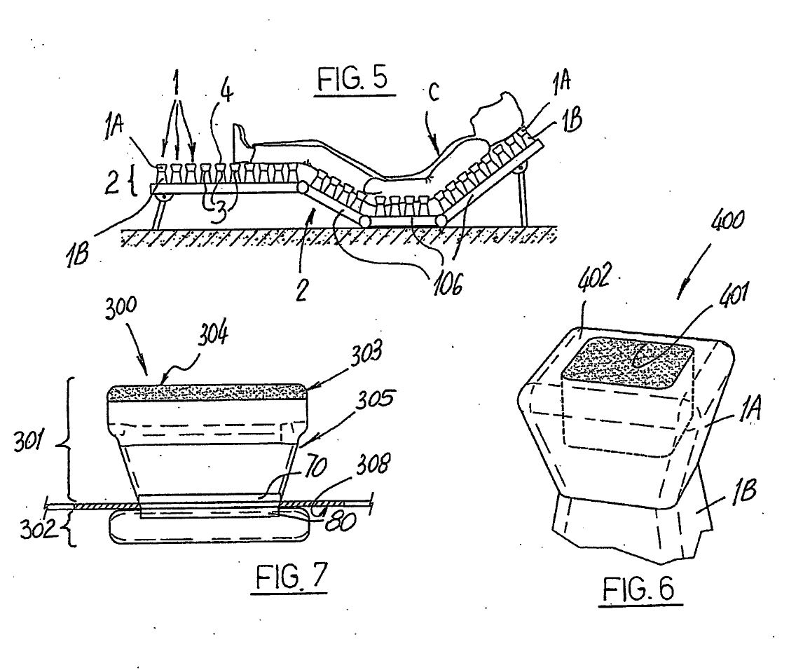

In a third embodiment of the modular supporting elements according to the invention, illustrated in FIG. 6 and indicated in this case with 400, a chamber 401 is created either in the upper portions 1A or resting portions 301; this chamber, however, does not take up the whole volume of the latter but only a portion, normally a central portion.

The chamber 401 is filled, also in this case, with a fluid or a gel that has first specific elastic properties, for example a first modulus of elasticity E1, while the portion 402 that contains the chamber 401 is made with a foamy polymer material that has elastic properties, for example a modulus of elasticity E2, different from those of the gel and which is normally more compact and less flexible.

According to the fifth embodiment of the modular supporting element illustrated in Figures from 15 to 21, it can be noticed that the modular element, indicated in this case with reference number 500, defines a first end 501 considered as a resting and support and an opposite end 502 considered as the base.

According to this fifth embodiment, each modular element 500 has a body that has a shape of the bellows type and in which portions 503, 504 and 505 are defined, substantially prismatic and all identical, which are connected together with further shaped coupling portions, each one like a perimeter groove and indicated with 506, 507 and 508 respectively.

At the end 501 of the modular element 500 an insert is provided that forms a chamber 509 in which can be put in and contained a fluid material, normally with a high density, like a gel, or a material at the loose state, for example sand or plastic material granules.

This chamber 509 is able to adapt itself spontaneously to the forms of a human body “C” and to maintain a pleasant and not traumatic contact with it.

With reference to FIG. 16, it can be observed that by putting near an adequate number of modular, supporting elements 500, it is possible to make a product like, for example, a mattress 2 or even a pillow (not illustrated).

To keep the various modular elements 500 joined together, a joining element, as in the embodiment illustrated in Figures from 8 to 10, is provided which is composed of a laminar element, practically a sheet 510, normally flexible, in which rows and columns of hollow seats 511 are obtained.

The perimeters of the hollow seats 511 and of the modular elements 500 are preferably, but not necessarily, joinable together and the perimeter dimensions of the hollow seats, 511 are such to require the temporary manual squashing of the modular elements 500 so they can be fitted inside them.

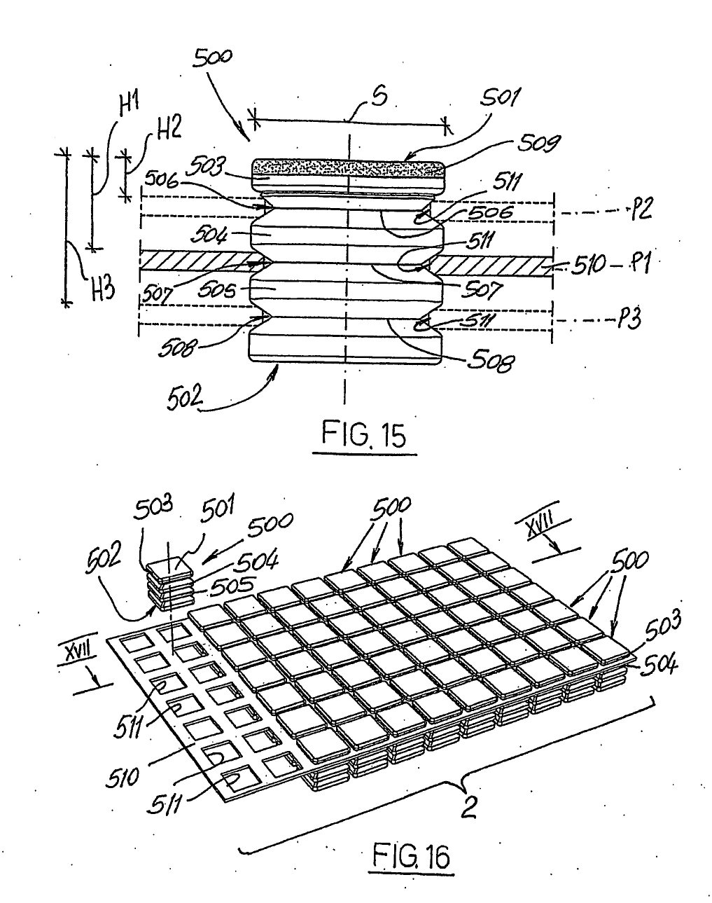

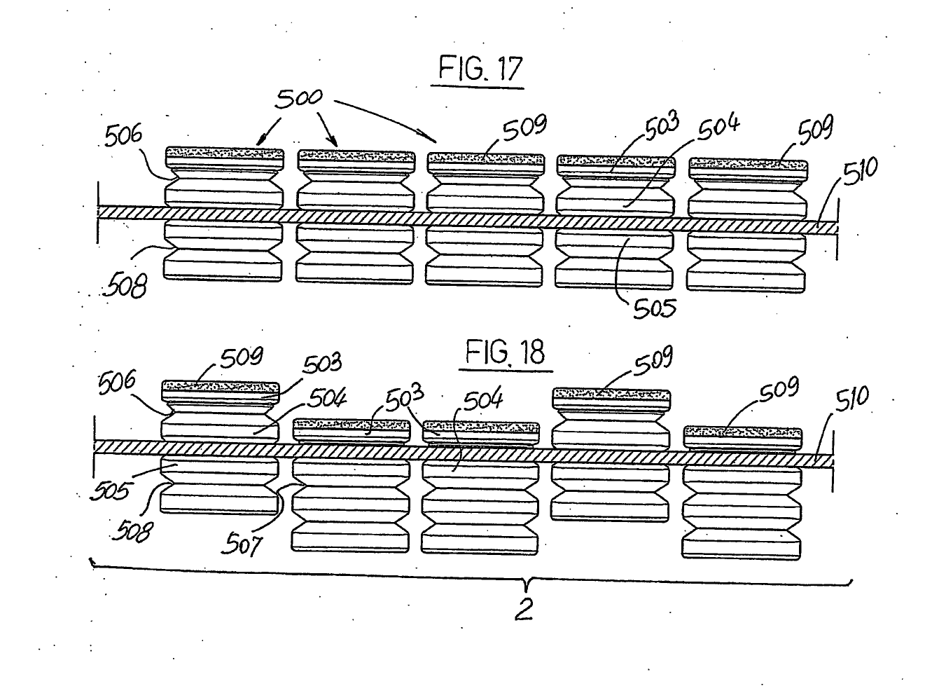

Once fitting inside is completed, the modular elements 500 are released and, being elastic, spring back to their original form, adapting themselves to the corresponding hollow seat 511 which hold them in place as illustrated in FIG. 15 and from 17 to 21.

With reference to FIG. 15, it can be observed that here three possible layouts are indicated between each modular element 500 and the relative hollow seat 511.

A first layout, indicated with P1, contemplates that the perimeter groove 507 engages with the edges that delimit the perimeter of the hollow seat 511; a second layout, indicated with P2, contemplates that it is the perimeter groove 506, that is engaged with the perimeter edges of the hollow seat 511; a third layout, indicated with P3, contemplates that it is the perimeter groove 508 that is engaged with the edges of the hollow seat 511.

As can be seen in this same FIG. 15, to each different layout P1, P2 and P3 corresponds a different height, indicated with H1, H2 and H3 respectively, of the modular element 500 or, more precisely, of the end of this element with respect to sheet 510.

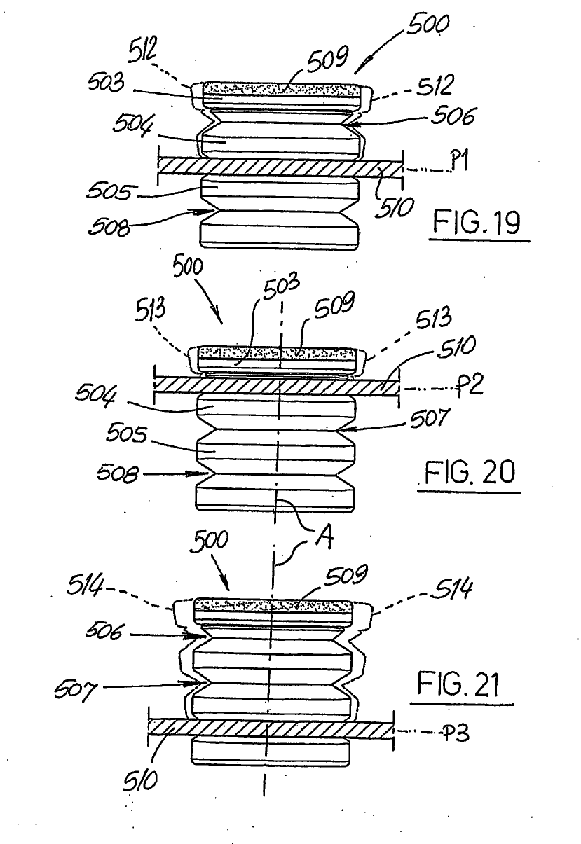

These same layouts P1, P2 and P3 are also visible in FIGS. 19, 20 and 21 in a slightly reduced scale.

In these Figures dotted lines have been used to indicate the possible bending that each modular element 500 can be subject to in relation to its own longitudinal track axis “A”, when stressed by a corresponding part of a human body resting on its end 501.

Again with reference to Figures from 19 to 21, it can be noticed that in the F1 layout the modular element 500 can bend in a median-upper zone (see the dotted lines 512), in the P2 layout in a substantially upper zone (see the dotted lines 513) and in the P3 layout in a zone that comprises the portions 503, 504 and 505 (see the dotted lines 514).

In other words it is possible to modify, according to necessity, the flexibility of each modular element 500 with respect to the surface of the sheet 510, changing the layouts between P1 and P3, while not altering the surface of the end 501, indicated with “S”.

In the case illustrated in the Figures, the perimeter grooves contemplated are a total of three to which the same number of possible layouts corresponds: however, for a person who is an expert in the sector, it is intuitive to reduce the number of these perimeter grooves to two or increase it to more than three when making the modular elements 500, in such a way as to obtain greater or fewer layout possibilities between the modular elements 500 and the sheet 510.

With reference to FIG. 18, it can be noticed that in the same mattress 2, for example areas with deformability differing one from the other have been defined, varying the layouts of the modular elements 500 in relation to the sheet 510.

In, this case too, a mattress 2 (or a pillow) obtained with the modular elements 500 inserted in the seats 511 is wrapped and closed inside a removable lining (not illustrated) that can be made with a fabric that has anti-allergic substances.

The use of the modular supporting element 1 in the first embodiment is the following: it is mounted, as explained above, together with the other elements 1 on a resting, base 6 or 106, and fixed to this base by tightening the screw 8 or by pressing on the portions that compose the strip 11, or by pressing the feet 200 into the corresponding hollow seats 201.

Once the assembly of the modular supporting elements 1 is completed, a softened resting surface is defined for the body “C” of a user, which is made up of all the resting faces 4 of the elements 1 arranged adjacently to each other.

Preferably, the latter all have the same height but, if required, they can be of different heights so as to form in a mattress 2 areas that are higher or lower, for example for a patient who has bulky plaster on a limb or a corset, while maintaining correct posture of the back bone.

When the body “C” rests on the mattress 2, the first upper portions 1A provide a first instant softening action (or first stage), deforming themselves mainly, but not only, according to the main direction “Z” of deformation, i.e. compressing themselves but also expanding elastically in directions transversal to it.

In this condition, the second lower portions 1B normally remain substantially intact and provide the supporting action for the body “C”.

If, for any reason, the pressure on the resting faces 4 increases considerably then the second lower portions 1B deform elastically as well, collaborating with the portions 1A in providing a softening action, although it is less softening than that of the first upper portions 1A.

This happens because it is contemplated that the elastic properties, for example the modulus of elasticity E2 of the second lower portion 1B, are less than those of, for example, the modulus of elasticity E1 of the first upper portion 1A.

It should, however, be pointed out that, in some cases, the second lower portion 1B can be more elastic than the first upper portion 1A.

This happens when, according to a possible embodiment of the modular supporting element 1, the second lower portion 1B is made according to a grid structure which, in this case, renders it far more deformable than the first upper portion 1A.

If it is necessary to replace one or more of the elements 1 with others due, for example, to damages or specific requests from the user, all that has to be done is to remove from the bases 6 or 106 the elements 1 that need changing and replace them with others that are similar or with other elasticity characteristics.

According to a possible embodiment of the invention, illustrated in FIGS. 5 and 11, the bases 6 and 106 can be composed of several modular elements connectable together: this makes it possible, in the case of necessity, to dismantle these bases 6 or 106, transforming them into modular elements which take up very little room on their own, and to dismantle the elements 1 from the bases 6 and 106 and, taking things all round, to easily transport the completely dismantled mattress 2 in all its component parts; that can be put in a bag or packed for transport, making transporting and handling extremely easy even with small vehicles or simply by hand.

In yet another embodiment of the modular supporting element 300, illustrated in Figures from 7 to 10, to make a mattress 2, or a pillow, the sheet 309 can be prepared in such a way that it has originally the dimensions of the resting surface of a single or double mattress or of a pillow.

The modular supporting elements 300 are then inserted inside the respective housing holes 307, temporarily pressing them so the base portions 302 can go through them.

When a modular supporting element 300 is inserted in the respective hole 307 and released, it elastically springs back to its original shape and is held inside the hole 307, by the flare of the intermediate portion 305 surface on one side and, on the other side, by the ring-shaped border 306 which, extending itself after going through the hole 307, comes to rest against the face 310 of the sheet 309.

When all the holes 307 have been filled with the corresponding modular supporting elements 300, the mattress 2, or the pillow, is finished and can be put on a structure of a bed or even put directly on the floor or used as a movable covering for armchairs, chairs, sofas and the like.

With this additional embodiment of the invention it is also possible to obtain from the one same sheet 309 that has big dimensions corresponding, for example to those of a double mattress 2, also a single mattress or just a pillow.

For this purpose it is possible to fold the sheet 309 substantially along at least one longitudinal folding line, for example a symmetrical central line, creating two layers, normally substantially the same 320 and 330, as indicated in FIGS. 10 and 13, that can be overlapped together in a book fashion, so the holes 307 of a layer are substantially coaxial with the holes 307 of the other layer thus allowing the insertion of the modular supporting elements 300 in pairs of overlapping holes 30; in this case, the modular supporting elements 300 also acts as buttons to hold the two layers 320 and 330 together.

Making, if necessary, additional folds and the consequent creation of other overlappable layers, it is possible to reduce the size of the sheet 309 further still until it reaches the size of a pillow, or to shape the sheet 309 as wanted, for example eliminating one corner of it, as schematically indicated in FIG. 14.

The fifth embodiment of the modular supporting element 500 illustrated in Figures from 15 to 21, works as follows: each modular element 500 is inserted in a respective hollow seat 511, by pressing it momentarily, until it is right inside and then released so it expands and springs back to its original dimensions.

The P1, P2 or P3 layout of each modular element 500 inside the hollow seats 511 is established previously so as to obtain a mattress 2, or a pillow or the like, that has alternatively a substantially constant flexibility over the entire supporting surface or different from point to point, for example less flexible in the areas that are to support the back of a human body “C” and more flexible where the legs and head are.

This difference in elastic deformability is obtained by modifying the distances H1, H2 and H3 between the ends 501 of each modular element 500 and the sheet or the joining element 510.

As a matter of fact, the less distance there is, for example like H1, the less deformable the modular element 500 will be and, therefore, the end 501 that forms the resting and support surface will be more rigid.

The opposite happens when the distance is greater, for example like H2 or H3, to which P2 and P3 layouts correspond.

In this latter layout, the elastic deformability of a modular element 500 is maximum with respect to the sheet 510 and, therefore, when a human body “C” is resting on the surfaces 501 it is particularly soft.

Also in this case it is possible to shape or reduce the overall dimensions of the sheet 510 as wanted by folding it, for example in two overlapping layers that are fixed together in this folded configuration by inserting one or more modular elements 500 in pairs of hollow seats 511 overlapping and aligned together in a substantially coaxial way.

Also in this fifth embodiment of the modular element 500, as can be seen in the Figures, the end 501 can have a containment chamber 509 with flexible walls and which is, designed to hold a material at either the loose or liquid state, for example gel, which makes contact with a human body “C” particularly pleasant.

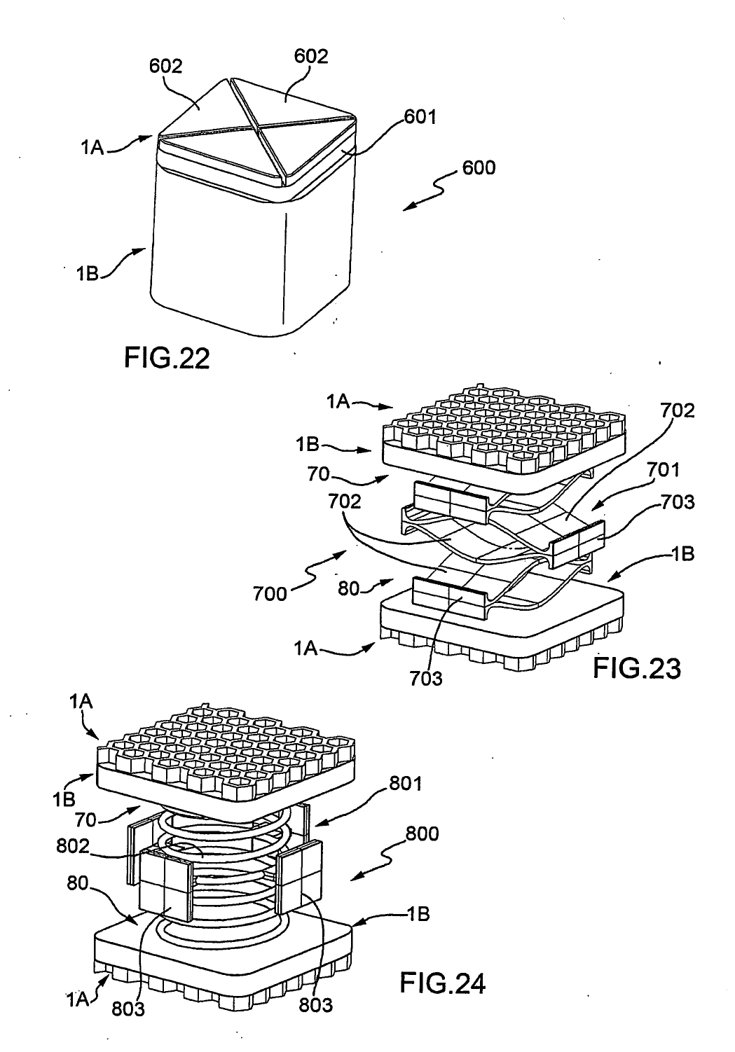

A sixth embodiment of the modular supporting element according to the invention is illustrated in FIG. 22, indicated with 600. In this sixth embodiment the first upper portion 1A and the second lower portion 1B are shaped substantially as a parallelepiped with rounded edges, the second lower portion being higher than the first upper portion 1A. The first upper portion 1A comprises a sort of flattened base 601, made of an elastically deformable, material, such as, for example, plastic/elastomeric foam or a thermoplastic material. Above this there are four triangular elements 602, which define air circulation channels, in which a fluid substance, such as a gel, is accumulated. Alternatively, the first upper portion 1A may consist of squares, or other differently shaped elements, defining air circulation, channels. The second lower portion 1B is made of an elastically deformable material, such as plastic/elastomeric foam or a thermoplastic material: this material may be, for example, the same from which the flattened base 601 is made. An additional first portion 1A may also be provided, fixed to the opposite end of the second lower portion 1B, so as to make mattresses, pillows and the like with two opposing faces both provided with surfaces in which there is a fluid, such as gel.

A seventh embodiment of the modular supporting element according to the invention is illustrated in FIG. 23, indicated by 700. The modular supporting element in this seventh embodiment comprises two first portions 1A, each of which are associated with respective second portions 1B made of an elastically deformable material, such as plastic/elastomeric foam or a thermoplastic material; between the two second portions 1B there are joining means 70, 80 which comprise elastic means 701. These elastic means 701 comprise, for example, leaf springs 702, reciprocally overlapping with alternating spatial alignments so as to form a composition with adequate thickness and high elastic characteristics, different from those of the plastic/elastomeric foam type material. The leaf springs 702 laterally define respective vertical plates 703 which contribute towards maintaining the supporting element 1 permanently in a vertical position. The leaf springs 702 may be associated with an outer casing.

In this seventh embodiment the first portions 1A comprise honeycomb structures, made; for example, with a fluid such as a gel, or with another adequate material such as a thermoplastic elastomer, known with the abbreviation TPE; these structures have different elastic properties to those of chambers completely filled with fluid; in particular they have a greater pliability.

In another alternative embodiment, the leaf springs 702 may be incorporated in a layer of plastic/elastomeric foam type material or thermoplastic material.

An eighth embodiment of the modular supporting element according to the invention is illustrated in FIG. 24, indicated by 800. In this eighth embodiment the modular supporting element comprises two first portions 1A, each of which are associated with respective second portions 1B made from elastically deformable material, such as, for example, plastic/elastomeric foam or a thermoplastic material; between the two second portions 1B there are joining means 70, 80 which comprise elastic means 801. These elastic means 801 comprise, for example, a coil spring 802, with the respective ends fixed to the second portions 1B, so as to form a composition with adequate thickness and high elastic characteristics, different from those of the plastic/elastomeric foam type material to and from those of the leaf springs. The coil spring 802 is laterally associated with respective vertical plates 803 which contribute towards maintaining the supporting element 1 permanently in a vertical position. The coil spring 802 may be associated with an outer casing.

In this eighth embodiment the first portions 1A comprise honeycomb structures, made, for example, with a fluid such as a gel, or with another adequate material, such as TPE; these structures have different elastic properties to those of chambers completely filled with fluid; in particular they have a greater pliability.

In another alternative embodiment, the coil spring 803 may be incorporated in a layer of plastic/elastomeric foam type material.

In yet other embodiments, the joining means 70, 80 may comprise elastic means of another type, comprising, for example, one or more springs with other shapes and/or forms.

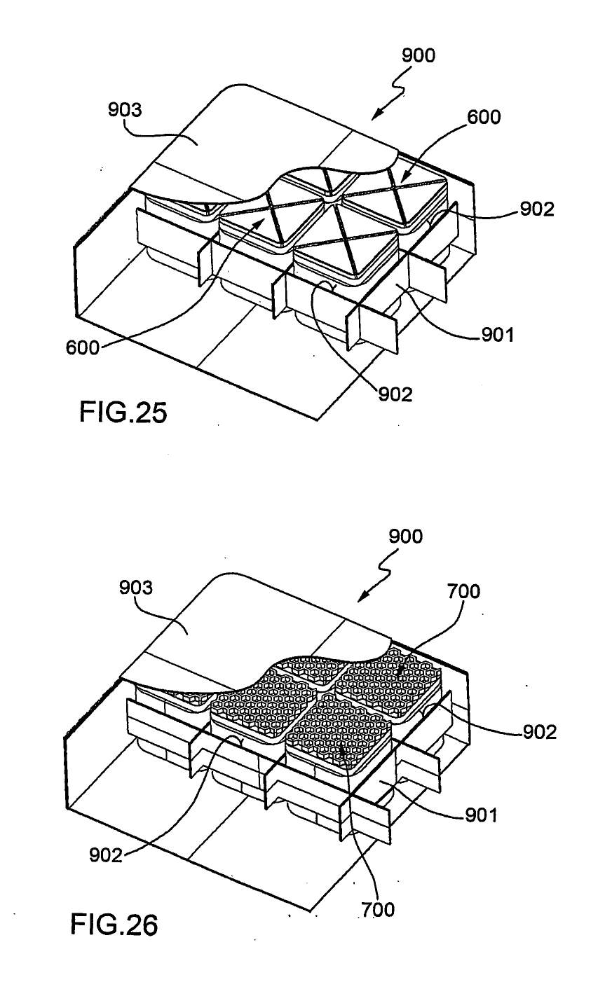

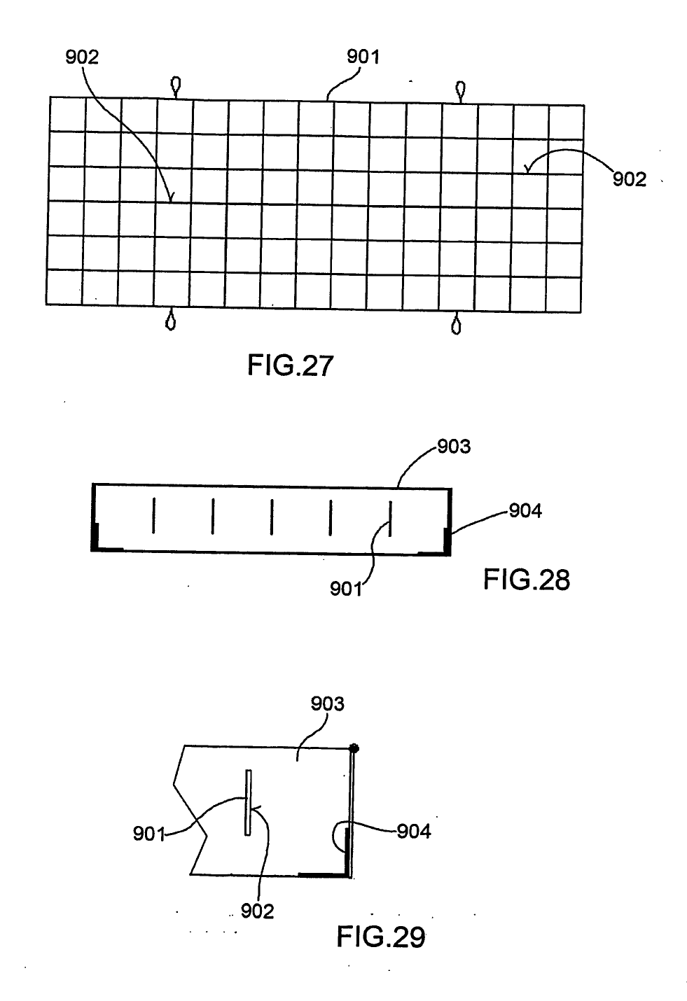

FIGS. 25, 27, 28 and 29 illustrate in detail an alternative embodiment of a mattress, made in particular with the supporting elements of FIG. 22, indicated as a whole with 900.

In this embodiment the mattress is made by inserting a plurality of supporting elements in a joining element 901 shaped substantially as a grid. This joining element 901 defines a plurality of cells or pockets 902 in which the supporting elements are inserted individually and adjacent to one another. The joining element 901 may be made of a substantially pliant material, so as not to adversely affect the flexibility of the supporting element and, therefore, the mattress in general. For example; the joining element 901 may be: made of natural or synthetic fabric, non-woven fabric or any other adequate material having equivalent characteristics, such as, for example, elastomeric material. The mattress 900 comprises a sheath 903 which encloses the joining element 901 with the supporting elements 1; as shown in FIGS. 28 and 29, the sheath 903 is fitted, at the edges, with stiffening elements 904 to give opportune firmness to the product, which is, however, substantially flexible thanks to the presence of the joining element 901 having the above-mentioned characteristics.

Another alternative embodiment of the mattress is illustrated in FIG. 26, in which supporting elements are fitted in the pockets 902 defined in the joining element 901 as shown in FIG. 23 or 24.

As an example, each of the supporting elements of the previously described embodiments may be made with a square base and with a ratio between the base side and the height of between 0.6 and 1.2; in a embodiment of this invention the ratio between the base side and height is approximately 0.78.

These ratios between the base and height dimensions of the supporting elements also permit the supporting elements to be self-supporting without the need for specific support structures. The supporting elements can be provided with a covering layer, by film or textile or coated, on all the surfaces of the element, eventually excluding the base of the element.

An evident advantage which distinguishes the mattress according to this invention consists in the fact that the supporting elements 1 are elastically compressible independently from one another, without appreciable friction between the adjacent lateral surfaces or the surfaces in contact with each supporting element and thanks to the covering layer and also to the stability and self-supporting characteristics of each element.

This characteristic allows a precise elastic strength to be obtained in each surface area of the mattress, which adapts to support in an optimum manner the part of the body which rests on it, unlike, for example, prior art mattresses which have a continuous support surface, and determine an effect similar to that of a hammock.

This result is particularly favourable, for example, in order to avoid bed sores or other similar unpleasant situations.

In addition, this characteristic favours the circulation of air and transpiration in the mattress, thanks to the presence of the interspaces 15 along the sides of the supporting elements 1.

Also, the mattress made in this way is perfectly reversible, that is, it has the same elasticity characteristics on both sides.

This invention has been described according to a preferred form of embodiment, but it may be modified and adapted in several ways without departing from the scope of the inventive concept.

1. A modular supporting element suitable for making mattresses, pillows and the like (2), comprising a supporting body (1) which is elastically deformable according to at least one direction, characterised in that the body comprises a first portion (1A) having first elastic properties and at least a second portion (1B) joined with the first portion (1A) by joining means (70, 80) and having second elastic properties which are different from the first elastic properties, characterised in that the first portion (1A) comprises a hollow or open chamber (5; 401), or at least one layer with one or more materials selected from the group consisting of: gel, polyurethane gel, thermoplastic elastomer (TPE).

2. The modular element according to claim 1, characterised in that the body comprises at least an adjacent upper portion (1A) and at least an adjacent lower portion (1B) with respect to the direction, or at least two adjoining portions with respect to the direction.

3. The modular element according to claim 1, characterised in that the joining means are chosen among gluing means, co-moulding means, over-moulding means or first joining elements (70) associated with the first portion (1A) and second joining elements (80) associated with the second portion (1B) and suitable for coupling with the first elements (70).

4. The modular element according to claim 1, characterised in that the first elements (70) and the second elements (80) can be coupled together in a removable way.

5. The modular element according to one or more of the foregoing claims, characterised in that the hollow or open chamber (5; 401) is suitable for containing a filling material.

6. The modular element according to claim 5, characterised in that the filling materials chosen among gel materials, aeriform materials, granular materials, fluid materials.

7. The modular element according to one or more of the foregoing claims, characterised in that at least the first portion (1A) and/or at least the second portion (1B) each comprises a body obtained from a single piece.

8. The modular element according to claim 7, characterised in that the single piece body comprises a body made from elastic material.

9. The modular element according to claim 8, characterised in that the elastic material is chosen among foam type material: polyurethane, ethyl-vinyl-acetate, latex, rubber, neoprene, polyethylene.

10. The modular element according to one or more of the foregoing claims, characterised in that at least the first upper portion (1A) defines a contact surface (4; 304) with a body.

11. The modular element according to claim 10, characterised in that the contact surface (4; 304) may be covered with covering means (12; 17) made from materials chosen from among anti-allergic materials and medical materials.

12. The modular element according to claim 11, characterised in that the contact surface (4; 304) comprises massaging and/or skin-stimulating means (13; 14).

13. The modular element according to one or more of the foregoing claims, characterised in that at least the second lower portion (1B) comprises fastening means (7) to be fastened to a support base (6; 106).

14. The modular element according to claim 13, characterised in that the fastening means (7) are removable.

15. The modular element according to claim 13 or 14, characterised in that the fastening means (6) are chosen between means (8) that can be fixed by screwing and elements (11) that can be fastened by pressure and released by traction.

16. The modular element according to one or more of the foregoing claims, characterised in that at least the first portion (1A) and at least the second portion (1B) are made with different materials respectively.

17. The modular element according to one or more of the foregoing claims, characterised in that the joining means (70, 80) comprise elastic means (701, 801).

18. The modular element according to claim 17, characterised in that the elastic means (701) comprise at least one leaf spring (702).

19. The modular element according to claim 17, characterised in that the elastic means (801) comprise at least one coil spring (802).

20. The modular element according to one or more of the foregoing claims, characterised in that the portion (1A) has a honeycomb structure.

21. The modular element according to one or more of the foregoing claims, comprising two of the first portions (1A) positioned on the opposite bases of the modular element.

22. The modular element according to one or more of the foregoing claims, characterised in that the element has a substantially square base and with a ratio between base side and height of between 0.6 and 1.2

23. The modular element according to claim 22, characterised in that the element has a ratio between base side and height of between of approximately 0.78.

24. A mattress, pillow and the like, characterized in that it comprises two or more modular supporting elements (1; 300; 400; 500; 600; 700; 800) according to one or more of the foregoing claims.

25. The mattress, pillow and the like according to claim 24, characterised in that the modular supporting elements (1; 300; 400; 500; 600; 700; 800) comprise covering layer, by film or textile or coated, on all the surfaces of the elements, eventually excluding the base of the elements and are elastically deformable independently from one another, without appreciable friction between the lateral surfaced adjacent or in contact with each modular supporting element thanks to the covering layer.

26. The mattress, pillow and the like according to claim 24 or 25, comprising a plurality of modular supporting elements (1; 300; 400; 500; 600; 700; 800) elastically deformable in at least one direction and maintained substantially adjoining one another with joining means (308; 901), characterised in that between the modular elements in the adjoined configuration there are free transit interspaces (15).

27. The mattress, pillow and the like according to one or more of the foregoing claims from 24 to 26, characterised in that the modular supporting elements (1; 300; 400; 500; 600; 700; 800) may be grouped together on modular portions of respective support bases which are reciprocally assembled together with fastening means so as to form support bases with the desired profiles.

28. The mattress, pillow and the like according to one or more of the foregoing claims from 24 to 27, characterised in that the modular supporting elements (1; 300; 400; 500; 600; 700; 800) may be wrapped around the perimeter with a wrapping element.

29. The mattress, pillow and the like characterised by:
laminar joining means (309) or grid joining means (901);
through holes (307; 511) or pockets (902) formed in the joining means (309; 901) and positioned according to a pre-defined distribution;
modular supporting elements (1; 300; 400; 500; 600; 700; 800) elastically deformable and which may be placed in the through holes (307; 511), the modular supporting elements provided with at least respective support surfaces (4; 304).

30. The mattress, pillow and the like according to claim 29, characterised in that the laminar joining means comprise at least a sheet (309) of plastic material.

31. The mattress, pillow and the like according to claim 30, characterised in that the modular elements each comprise a body comprising:
a supporting portion (1A);
a base portion (1B) which may be joined to the supporting portion (1A) by joining means (70, 80) positioned in a joining area, the supporting portion (1A) comprising at least a containment chamber (5; 401), set up to contain a fluid having first elastic properties.

32. The mattress, pillow and the like according to claim 31, characterised in that the base portion (1B) is made of elastic material which has second elastic propertied different to the first elastic properties.

33. The mattress, pillow and the like according to claim 31, characterised in that the joining means comprise:
a first joining element (70) associated with the supporting portion (1A);
a second joining element (80) associated with the base portion (1B) which may be coupled with the first joining element (70) in a removable/non-removable manner;

34. The mattress, pillow and the like according to any of the foregoing claims from 27 to 31, characterised in that the grid joining means (901) comprise a grid made of pliant material, defining pockets (902) for the insertion of modular elements (1; 300; 400; 500; 600; 700; 800).

35. The mattress, pillow and the like according to claim 34, characterised in that the grid joining means (901) is made of natural or synthetic fabric, non-woven fabric or any other adequate material having equivalent characteristics, such as, for example, elastomeric material.

36. A method for making mattresses, pillows and the like to support a body comprising the steps of:
arranging a joining element (6; 106; 308; 901) for modular supporting elements with fastening means;
coupling the modular supporting elements (1; 300; 400; 500; 600; 700; 800) in a removable/non-removable manner with the fastening means, characterised in that the modular supporting elements (1; 300; 400; 500; 600; 700; 800) have at least a first elastically deformable portion (1A) and a second portion (1B) which may be fastened to the first portion (1A) according to a direction of deformation.

37. The method according to claim 36, characterised in that the joining means comprise at least a supporting and fastening base (6; 106) which may be shaped according to pre-defined shapes.

38. The method according to claim 37, characterised in that the supporting base (6; 106) is formed with modular elements (107) which may be assembled together.

39. The method according to claim 38, characterised in that the joining means comprise laminar joining means (309) or grid joining means (901).

40. The method according to claim 39, characterised in that the laminar joining means comprise at least a sheet element (309) fitted with seats (307; 511) for housing and holding the modular supporting elements (1; 300; 400; 500; 600; 700; 800).

41. The method according to claim 40, characterised in that the sheet element (309) is flexible.

42. The method according to claim 39, characterised in that the grid joining means (901) comprise a grid of pliant material, defining pockets (902) for inserting the modular elements (1; 300; 400; 500; 600; 700; 800).

43. The method according to claim 42, characterised in that the grid joining means (901) are made of natural or synthetic fabric, non-woven fabric or any other adequate material having equivalent characteristics, such as, for example, elastomeric material.
